(19) United States
(12) Patent Application Publication
(10) Pub. No.: US 2015/0326873 A1
(43) Pub. Date: Nov. 12, 2015

(54) IMAGE FRAMES MULTIPLEXING METHOD AND SYSTEM

(71) Applicant: IMAX Corporation, Mississauga (CA)

(72) Inventors: Weining TAN, Mississauga (CA); Matthew O'DOR, Toronto (CA); Steven Charles READ, Mississauga (CA)

(21) Appl. No.: 14/799,044

(22) Filed: Jul. 14, 2015

Related U.S. Application Data
(63) Continuation of application No. PCT/CA2013/000028, filed on Jan. 15, 2013.

(51) Int. Cl. H04N 19/503; H04N 21/2343; H04N 19/44; H04N 21/4402; H04N 21/81; H04N 19/597; H04N 21/236; H04N 21/434

(52) U.S. Cl. CPC H04N 19/503; H04N 21/23602; H04N 21/2343; H04N 21/234372; H04N 21/4342; H04N 21/440272; H04N 21/816; H04N 19/597; H04N 19/44

(57) ABSTRACT

Embodiments of the present disclosure are directed towards a method of encoding image frames into a multiplexed frame, and a corresponding method of decoding the multiplexed frame. The encoding method includes modifying image frames to generate corresponding processed frames, and generating masking data that indicates how an output frame can be produced from one of the processed frames and another of the processed frames. The processed frames and the masking data can be combined to form a multiplexed frame. The decoding method includes receiving a multiplexed frame containing processed frames and masking data, and unpacking the multiplexed frame to identify the processed frames and the masking data. Once unpacked, an output frame can be generated from the processed frames by combining one of the processed frames with another of the processed frames according to the masking data.

### CROSS-REFERENCE TO RELATED APPLICATION

This application is a continuation of PCT International Application No. PCT/CA2013/000028, filed Jan. 15, 2013. The entire content of PCT Application No. PCT/CA2013/000028 is incorporated herein by reference.

### FIELD

The described embodiments relate to image processing processes, and more particularly, to encoding and decoding multiple image frames into a reduced number of multiplexed frames.

### BACKGROUND

Any existing image data transmission or processing infrastructure typically has a limited data bandwidth. This bandwidth is normally sufficient to serve the functions that the infrastructure was designed for (e.g., providing video at a given resolution or quality). However, once enhanced or new functions are required (e.g., video of a higher image quality is desired to be transmitted), the infrastructure typically needs to be upgraded or replaced. This upgrade or replacement process may involve changing hardware, software and/or network connections between components (especially if higher data bandwidth is necessary with the new functions and the system algorithms and protocols remain unchanged).

For example, digital cinematic video is typically provided at a frame rate of 24 frames per second (fps), with each frame traditionally being provided at a resolution of what is known as 2K (2048×1080 or 2.2 megapixels) or 4K (4096×2160 or 8.8 megapixels). To display cinematic video at this frame rate and resolutions in a theatre, the theatre typically contains infrastructure that has sufficient bandwidth to transmit the cinematic video to the display device (e.g., a projector).

Recent developments in camera technology have allowed the capture of digital cinematic video at higher frame rates (commonly known as HFR video). For example, the frame rates of these videos may be provided at 48 fps, 60 fps, or even 120 fps at a given spatial resolution. With HFR video, the amount of data to be transmitted to the display device is greatly increased.

As technology evolves, digital cinematic video may begin to be provided at image spatial resolutions higher than 2K and 4K. Even at existing frame rates, these higher-resolution video streams may also increase the amount of data to be transmitted to the display device.

Moreover, multiple-view video streams are gaining in popularity (e.g., stereoscopic videos streams providing a three-dimensional (3D) viewing experience). These types of video streams require higher transmission bandwidth than normal single view (e.g., two-dimensional (2D)) video streams.

Existing infrastructure at theatres may not provide sufficient bandwidth to allow transmission of these newer types of video streams to the display device. To upgrade the existing infrastructure, especially the hardware, software and/or system connection bandwidth is costly or undesirable. Accordingly, there is a need for alternatively improving the existing methods and systems of encoding and decoding image frames in an image stream, to allow for transmission of image frames of the new types of video streams over existing bandwidth-limited infrastructure.

### SUMMARY

In one aspect, some embodiments of the invention provide a method of dynamic frame packing, the method comprising:
identifying a plurality of image frames;
modifying each of the plurality of image frames to generate a plurality of corresponding processed frames;
generating masking data that indicates how an output frame can be produced from one of the plurality of processed frames and another of the plurality of processed frames, the output frame corresponding to the another of the plurality of processed frames; and
combining the plurality of processed frames and the masking data to form a multiplexed frame.

In another aspect, some embodiments of the invention provide a method of decoding a multiplexed frame, the method comprising:
receiving a multiplexed frame, the multiplexed frame comprising:
   a plurality of processed frames, and
   masking data;
unpacking the multiplexed frame to identify the plurality of processed frames and the masking data; and
generating a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames.

In another aspect, some embodiments of the invention provide a method of delivering multiplexed frames, the method comprising:
identifying an image frame stream;
selecting a plurality of image frames from the image frame stream;
modifying each of the plurality of image frames to generate a plurality of corresponding processed frames;
generating masking data that indicates how an output frame can be produced from one of the plurality of processed frames and another of the plurality of processed frames, the output frame corresponding to the another of the plurality of processed frames;
combining the plurality of processed frames and the masking data to form a multiplexed frame;
compressing the multiplexed frame to generate a compressed frame; and
transmitting the compressed frame.

In another aspect, some embodiments of the invention provide a method of displaying multiplexed frames, the method comprising:
receiving a compressed frame;
decompressing the compressed frame to generate a multiplexed frame, wherein the multiplexed frame comprises:
   a plurality of processed frames, and
   masking data;
unpacking the multiplexed frame to identify the plurality of processed frames and the masking data;
generating a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames; and
transmitting the plurality of output frames to at least one display device.

In another aspect, some embodiments of the invention provide a system for transmitting a multiplexed frame, the system comprising:
a receiving module configured to receive a plurality of image frames;
an encoding module configured to:
   modify each of the plurality of image frames to generate a plurality of corresponding processed frames;
   generate masking data that indicates how an output frame can be produced from one of the plurality of processed frames and another of the plurality of processed frames, the output frame corresponding to the another of the plurality of processed frames; and
   combine the plurality of processed frames and the masking data to form a multiplexed frame;
a compression module configured to compress the multiplexed frame to generate a compressed frame; and
a communication module configured to transmit the compressed frame.

In another aspect, some embodiments of the invention provide a system for decoding a multiplexed frame for display, the system comprising:
a decompression module configured to decompress the compressed frame to restore the multiplexed frame; and
a decoding module configured to:
   unpack the multiplexed frame to identify a plurality of processed frames and masking data; and
   generate a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames.

In another aspect, some embodiments of the invention provide a method of generating a nested multiplexed frame, the method comprising:
identifying a multiplexed frame comprising: a first processed frame that corresponds to a first image frame, and a second processed frame that corresponds to a second image frame;
identifying a third image frame;
modifying the multiplexed frame and the third image frame to generate a corresponding processed multiplexed frame and a corresponding third processed frame respectively;
identify masking data that indicates how an output frame can be produced from the second processed frame and the third processed frame, the output frame corresponding to the third image frame; and
combining the processed multiplexed frame, the third processed frame and the masking data to form a nested multiplexed frame.

In another aspect, some embodiments of the invention provide a method of decoding a nested multiplexed frame, the method comprising:
receiving a nested multiplexed frame, the nested multiplexed frame comprising:
   a processed multiplexed frame that comprises a first processed frame and a second processed frame,
   a third processed frame, and
   masking data;
unpacking the nested multiplexed frame to identify the processed multiplexed frame, the third processed frame, and the masking data;
decoding the processed multiplexed frame to identify the first processed frame and the second processed frame; and generating an output frame, wherein the generating comprises combining the second processed frame with the third processed frame according to the masking data, and wherein the output frame corresponds to the third processed frame.

### BRIEF DESCRIPTION OF THE DRAWINGS

A preferred embodiment of the present invention will now be described in detail with reference to the drawings, in which:

FIG. 1 is a block diagram showing a system for encoding and decoding multiplexed image frames, in accordance with at least one embodiment of the present disclosure;

FIG. 2 is a flowchart diagram showing a sequence of acts performed when encoding a plurality of image frames into a multiplexed frame, according to at least one embodiment of the present disclosure;

FIG. 3 is an illustration of a progressive transformation of image frames into a multiplexed frame, in at least one embodiment of the present disclosure;

FIG. 4 is an illustration of generating masking data, in accordance with at least one embodiment of the present disclosure;

FIG. 5 is a flowchart diagram showing a sequence of acts performed when decoding a multiplexed frame, according to at least one embodiment of the present disclosure;

FIG. 6 is an illustration of the transformation of a multiplexed frame into a plurality of output frames, in at least one embodiment of the present disclosure;

FIG. 7 is an illustration of producing an output frame by computing with two processed frames according to masking data, according to at least one embodiment of the present disclosure;

FIG. 8 is an illustration of the transformation of at least one multiplexed frame into a nested multiplexed frame, in accordance with at least one embodiment of the present disclosure;

FIG. 9 is an illustration of transforming a multiple-view image frame stream into a multiplexed image frame stream in which the image frames of different views are encoded together, in accordance with at least one embodiment of the present disclosure; and

FIG. 10 is an illustration of the transformation of a multiple-view image frame stream into a multiplexed image frame stream in which successive image frames of the same view are encoded together, in accordance with at least one embodiment of the present disclosure;

FIG. 11 is an illustration of the transformation of a single-view image frame stream into a multiplexed image frame stream in which successive image frames are encoded together, in accordance with at least one embodiment of the present disclosure; and

FIG. 12 is an illustration of another example layout of a packed frame, in accordance with an embodiment of the present disclosure.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

Particularly, the embodiments described herein relate to the field of image processing, and various drawings have been provided to illustrate the transformation of image data. It will be understood that the drawings are not to scale, and are provided for illustration purposes only.

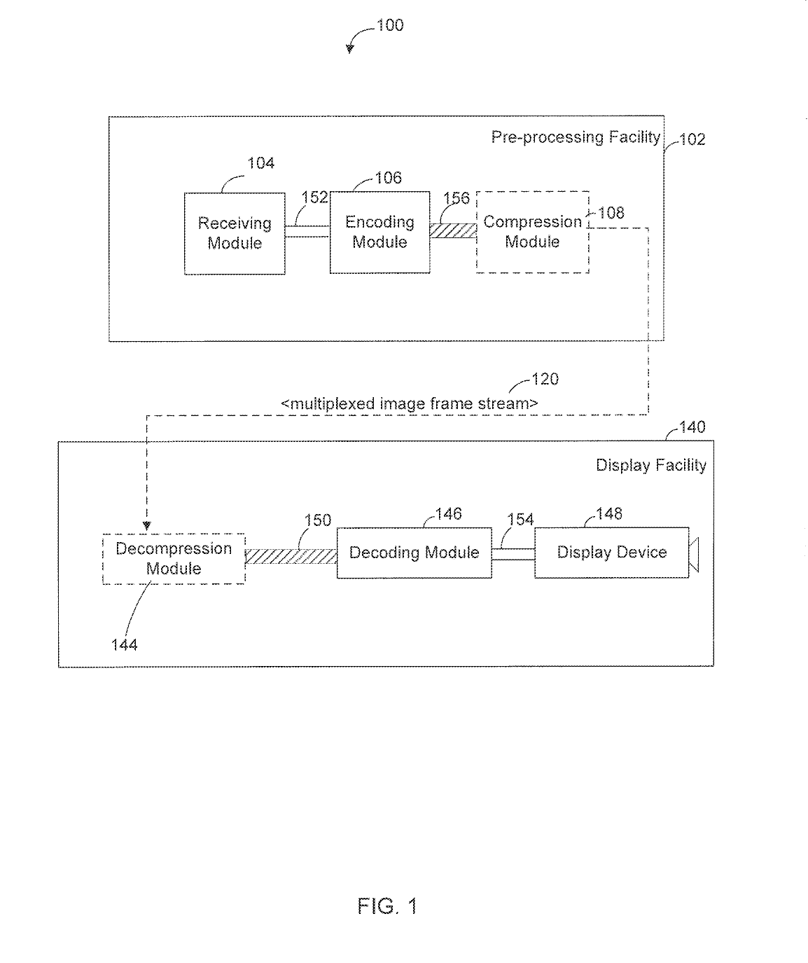

The embodiments of the systems and methods described herein may be implemented in hardware or software, or a combination of both. However, preferably, these embodiments are implemented in computer programs executing on programmable computers each comprising at least one processor (e.g., a microprocessor), a data storage system (including volatile and non-volatile memory and/or storage elements), at least one input device, and at least one output device. For example and without limitation, the programmable computers (e.g., the various devices shown in FIG. 1) may be a server computer, a mainframe, a computing cluster, a personal computer, laptop, smart-phone device, and/or a tablet computer. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic/optical diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Referring to FIG. 1, shown there generally as 100 is a block diagram showing an example system for encoding and decoding image frames, in accordance with at least one embodiment of the present disclosure. The system 100 may include a pre-processing facility 102 (e.g. a digital intermediate production workflow) that contains software modules (e.g., encoding module 106) that can be configured to generate a multiplexed image frame stream 120 from original video data, and a display facility 140 (e.g., a digital theatre) that includes various components which can be configured to receive and decode the multiplexed image frame stream 120 for display.

As will be understood, the various illustrated software modules may, in some embodiments, be implemented on one or more computer servers available at the pre-processing facility 102. Such server(s) may contain at least one processor and at least one memory storing various software modules containing instructions that when executed by the at least one processor, causes the at least one processor to perform acts of the illustrated software modules.

The pre-processing facility 102 may, optionally, also be provided with a compression module 108 (shown in dotted outline) that contains instructions that cause the processor to compress an image frame stream. The compression module may or may not be a part of the existing infrastructure. Further, the pre-processing facility 102 may be provided with various mechanisms to allow the transmission or storage of data. For example, such mechanisms may include network interface cards (e.g., for Ethernet, WiFi, etc.) or high-speed data ports (e.g., HD-SDI, HDMI, USB, Firewire, etc.) that allow a multiplexed image frame stream 120 to be transmitted over a communications network or stored on an external storage medium. These various mechanisms may be activated and/or controlled by, for example, a communication module (not shown) at the pre-processing facility 102.

It will be understood that in various embodiments, the compression module 108 may be provided on a different device from the pre-processing facility in FIG. 1, such that the multiplexed image frame stream 120 may be provided from this different device. In various embodiments, the pre-processing facility 102 may also include a receiving module 104 that is configured to receive a plurality of image frames. In various embodiments, the image frames may be digital cinematic video data that is provided as a high frame rate video stream or multiple-view video stream.

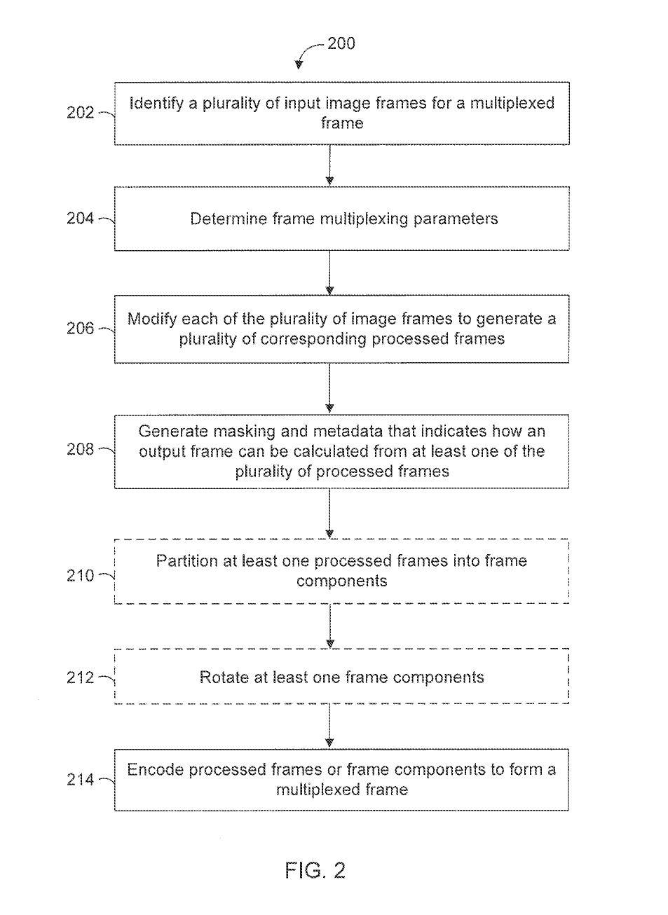

The encoding module 106 may be a stand-alone hardware device or a logical software component that contains the instructions to perform the method of encoding of image frames described below. Viewed from a high-level, the encoding module 106 may identify frames in the image frame stream received at the receiving module through a wider bandwidth channel 152, and then encode the original image frames into multiplexed frames. The multiplexed frames can then be transmitted through a narrower bandwidth channel 156 as a multiplexed image frame stream 120 that requires less bandwidth during transmission, so that the multiplexed image frame stream 120 can be provided to, and processed at, the display facility 140. The acts performed by the encoding module 106 will be described in greater detail below in relation to FIGS. 2-4.

If the compression module 108 is present on the pre-processing facility 102, the multiplexed image frame stream may be compressed prior to being transmitted and provided to the display facility 140. Such compression may be performed according to known video compression algorithms or specified by the existing system infrastructure. For example, if the compression module and the multiplexed image frame stream 120 are to be constructed according to the Digital Cinema Initiatives (DCI v1.0) specification, the multiplexed image frame stream would be compressed according to the ISO/IEC 15444-1 “JPEG2000” compression standard.

It will be understood that the acts performed by the encoding module 106 may be performed offline. That is, the encoding of an image frame stream to form a multiplexed image frame stream 120 need not be performed in real-time. Instead, the image frame stream may be processed by the encoding module 106 without any particular time constraint, and the resultant multiplexed image frame stream 120 may be transferred/transmitted to the display facility 140 after the entire multiplexed image frame stream 120 has been created.

Once created, the multiplexed image frame stream 120 may be provided to the display facility 140 (as illustrated, for example, by the dotted arrow from the compression module 108 to the decompression module 144 of the display facility 140). It will be understood that the multiplexed image frame stream 120 may be provided to the display facility 140 in any number of ways. For example, the multiplexed image frame stream 120 may be provided by way of a computer readable medium (such as a hard disk, optical disc or flash memory), which is then loaded onto a storage device (not shown) at the display facility 140. Additionally or alternatively, the frame stream 120 may be transmitted to the display facility 140 via computer network communications (e.g., the data may be transmitted over the Internet). Other methods of providing the frame stream 120 to the display facility 140 may also be possible.

The display facility 140 may include: a decoding module 146 that is able to decode the multiplexed frame stream 120 (e.g., so as to restore the frame stream for transmission through a wider bandwidth transmission channel 154); and a display device 148 (e.g., a projector) that displays the resultant video stream produced from the decoding module 146.

If the multiplexed image frame stream 120 has been compressed (e.g., by compression module 108) the display facility 140 may also optionally include a decompression module 144 (shown in dotted outline) that is configured to decompress the compressed multiplexed image frame stream 120 before the multiplexed image frame stream is provided to the decoding module 146. As discussed, the decompression may be performed according to the JPEG2000 standard if, for example, the multiplexed image frame stream 120 is provided according to the Digital Cinema Initiatives (DCI v. 1.0) specification. In variant embodiments, the decompression module 144 may be provided within the decoding module 146.

The decompression module 144 may contain a video or network interface component that allows the decompression module 144 to transmit the multiplexed image frame stream 120 to the decoding module 146. As will be understood, the decompression module 144 may contain a processor and a memory storing instructions that instruct the processor to interact with the video or network interface component.

In some embodiments, the decompression module 144 may be capable of processing the multiplexed image frame stream 120 in real-time without first storing the multiplexed image frame stream 120. Additionally or alternatively, the display facility 140 may include a storage device (not shown) that stores the multiplexed image frame stream 120, prior to the frame stream 120 being processed by the decompression module 144. Such a storage device may include a storage medium (such as a hard disk) to store the multiplexed image frame stream 120. In various embodiments, the decompression module 144 may be provided as an application executable on the storage device.

A bandwidth-limited transmission channel 150 (shown in FIG. 1 with crosshatch shading) may connect the decompression module 144 and the decoding module 146. The bandwidth-limited transmission channel 150 may be a part of existing infrastructure at a display facility 140 designed to transmit traditional cinematic video to a display device 148. Since traditional cinematic video is typically provided at frame rates of 30 fps or lower (e.g., traditional cinematic video has typically been provided at a frame rate of 24 fps), the transmission channel 150 may have insufficient bandwidth to allow for transmission of HFR (e.g., 48 fps) video that contains additional video data. For example, a 24 fps image frame stream containing cinema images at 2K resolution compressed by a JPEG2000 encoder typically requires a bandwidth of 250 Mbps for adequate quality. However, to transmit HFR video at 48 fps while retaining the same image quality, the HFR video stream would require double the bandwidth at 500 Mbps. The bandwidth-limited transmission channel 150 may not be able to provide this additional bandwidth. Transmitting 48 fps without increasing the bandwidth of the channel requires compressing individual frames to half as many bytes as would be used at 24 fps, and this may substantially lower image quality.

Due to the encoding performed by the encoding module 106 at pre-processing facility 102, the multiplexed image frame stream 120 may contain video data that is at a lower frame rate than that of the original HFR video. That is, because more than one original image frames of the HFR video can be encoded and compressed into one multiplexed frame, the frame rate for the stream of multiplexed frames 120 would be lower. Accordingly, the multiplexed image frame stream 120 may able to transmit HFR frame data across the bandwidth-limited communications channel 150. The multiplexed image frame stream 120 may then be restored into a HFR video stream by decoding the encoded frames in the multiplexed image frame stream 120, before the multiplexed image frame stream 120 is displayed by the display device 148.

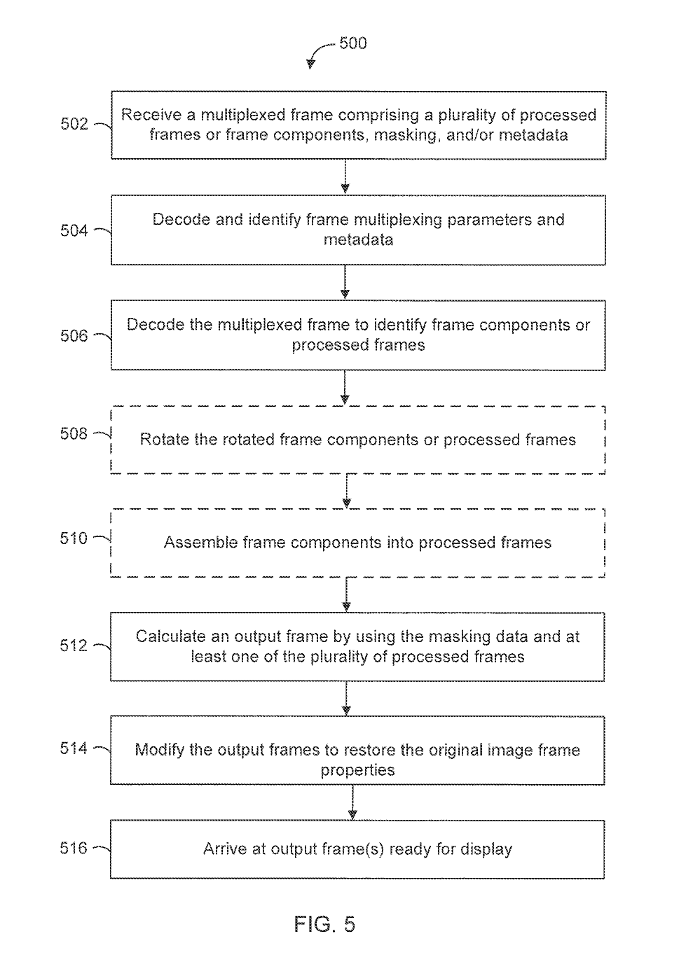

The decoding module 146 may be configured to perform the decoding of multiplexed frames. As will be understood, the connection 154 between the decoding module 146 and the display device 148 may vary. For example, the decoding module 146 may be provided as a separate computing device that has a high-bandwidth connection to the display device 148. Additionally or alternatively, the decoding module 146 may be provided as an add-on module of the display device 148. The various acts performed during the process of decoding a multiplexed frame will be described in greater detail below with respect to FIGS. 5-7.

### Encoding Image Frames to Form a Multiplexed Frame

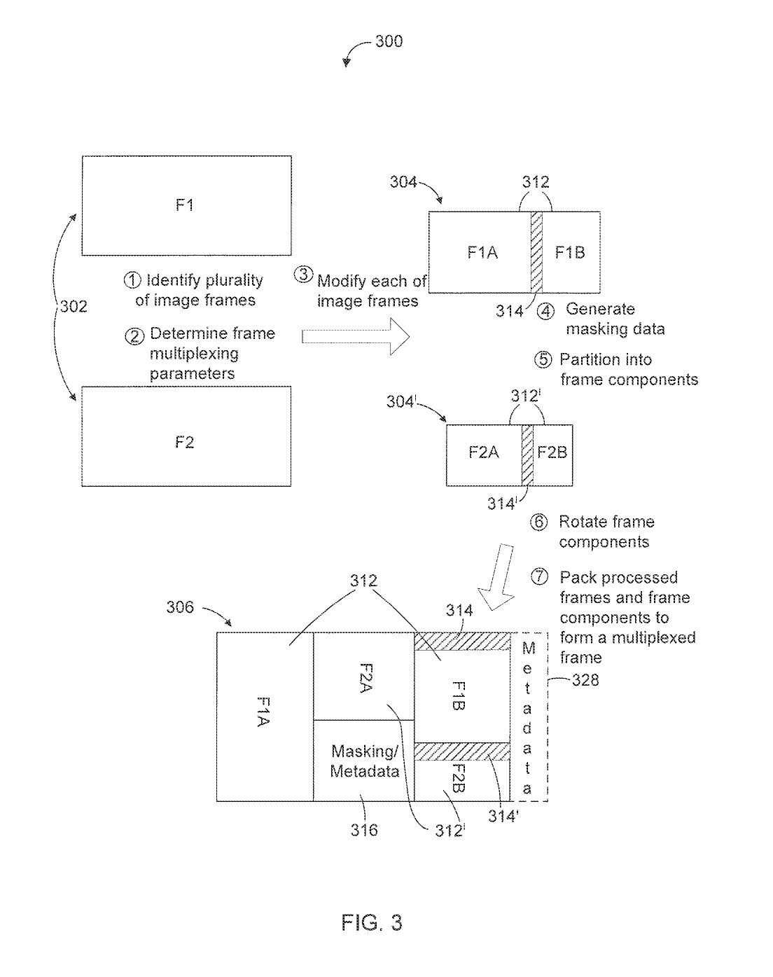

Referring to FIG. 2, shown there generally as 200 is a flowchart diagram showing a sequence of acts performed when encoding a plurality of image frames into a multiplexed frame, according to at least one embodiment of the present disclosure. For ease of explanation, reference will simultaneously be made to FIG. 3, which illustrates generally as 300, the progressive transformation of image frames into a multiplexed frame. Some of the acts illustrated in FIG. 2 are correspondingly shown in FIG. 3 (notated with a number in a circle) to better explain how the image frame data is modified during the execution of the steps shown in FIG. 2.

As noted, at least some of these acts may be performed by the encoding module 106 in the pre-processing facility 102 shown in FIG. 1.

Step 202 involves identifying a plurality of image frames for a multiplexed frame that is to be created. This may involve selecting the plurality of image frames from an original image frame stream such as an HFR video stream or multiple-view video stream. For example, the HFR video stream may be cinematic or television video that resulted from HFR footage captured using HFR-capable cameras (such as cameras manufactured by RED®, for example). In the embodiments discussed herein, the plurality of image frames selected from the image frame stream may be a pair of image frames; however, it will be understood that any number of image frames may be selected from an original image stream to be encoded into a multiplexed frame.

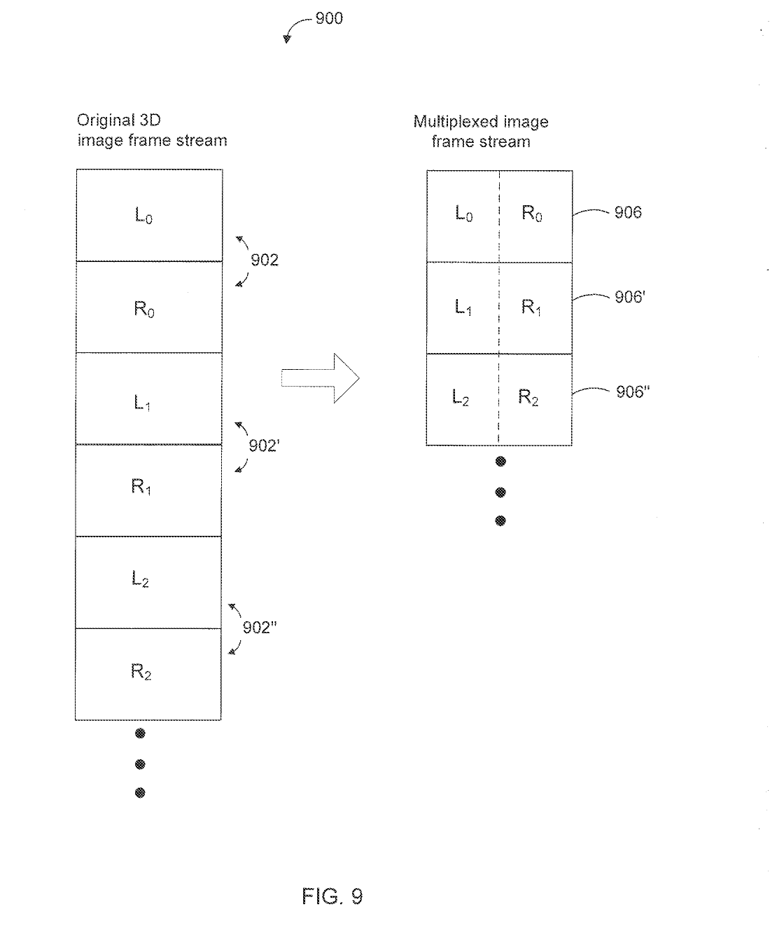

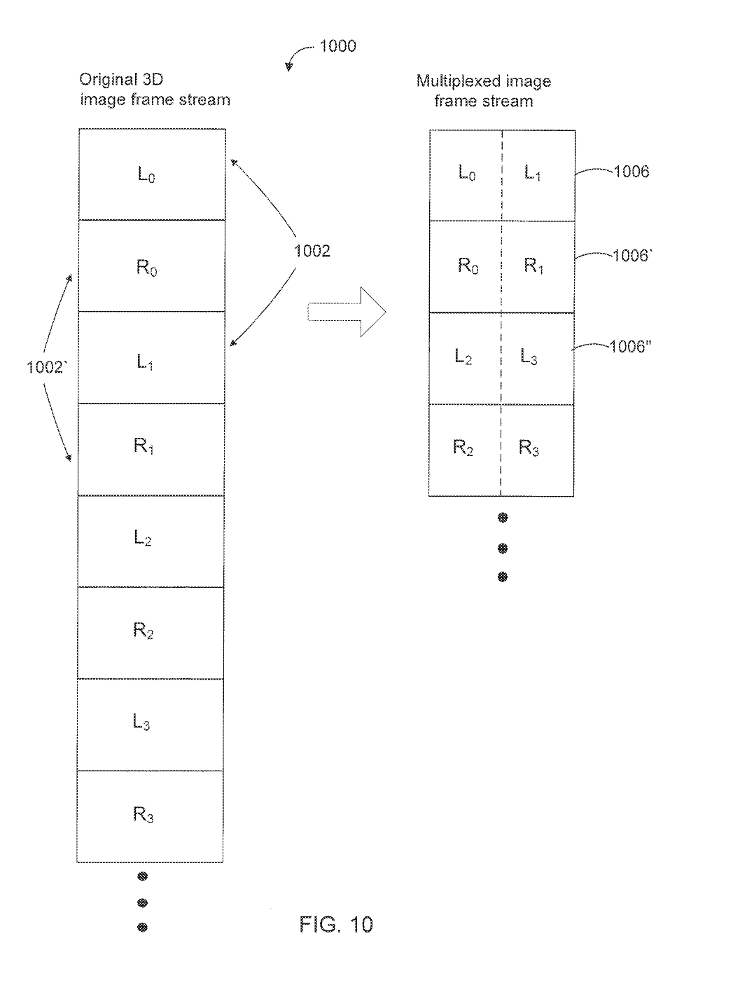

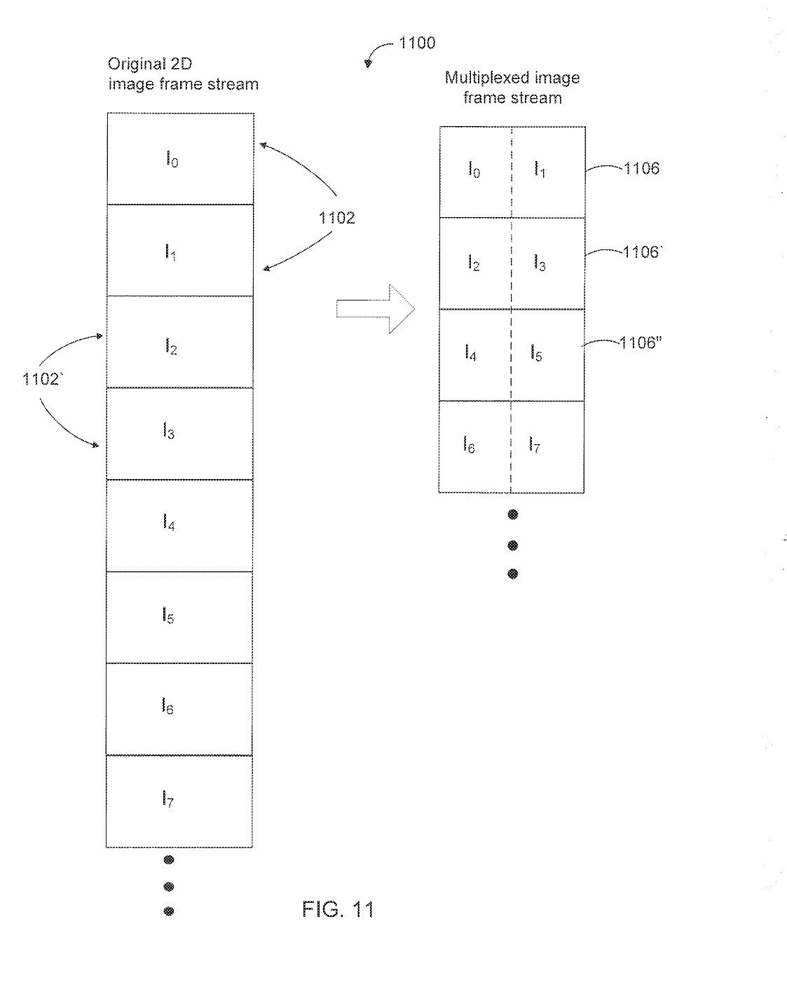

The selected image frames may be consecutive image frames in an original image frame stream (this scenario is generally illustrated, for example, at FIG. 11); however, in various embodiments, the selected image frames need not be sequential in nature. For example, as discussed below, the selected image frames may show a different view of the same scene, such as may be the case when the selected image frames are stereoscopic frame pairs that show three-dimensional (3D) video (this scenario is generally illustrated, for example, at FIGS. 9-10).

Referring simultaneously to FIG. 3, shown there are example image frames 302 (labeled ‘F1’ and ‘F2’) that have been identified by selecting from an original image frame stream (the identifying act shown at circle number 1). The original image frames 302 may be provided at an original resolution. For example, the resolutions of the image frame streams may be provided at what is known as 2K (2048×1080 or 2.2 megapixels) or 4K (4096×2160 or 8.8 megapixels).

At step 204 in FIG. 2 (and circle number 2 in FIG. 3), the method may proceed to determine the frame multiplexing parameters for the multiplexed frame to be created. The frame multiplexing parameters may contain data that indicates the type of image frames that are to be multiplexed into a multiplexed frame, and/or how the image frames are to be multiplexed. For example, as will be discussed below, the frame multiplexing parameters may indicate if one of the image frames to be encoded is already a multiplexed frame (such that a nested multiplexed frame is to be generated). In another example, the frame-packing parameters may indicate if multiple-view image frames are to be encoded into a multiplexed frame. In yet another example, the frame-packing parameters may indicate dimension information of the image frames are to be encoded into a multiplexed frame. In various embodiments, the frame multiplexing parameters may be added to the metadata encoded in the multiplexed frame, as discussed below.

At step 206, a resolution of each of the plurality of image frames is modified to generate a plurality of corresponding processed frames. This modification may include any processing that can modify the resolution of an image frame. For example, this processing may include modifying an aspect ratio of the image frame, vertically compressing the image frame, and/or horizontally compressing the image frame. The modification of the resolution of the image frames may be performed by image resampling algorithms, for example.

Step 206 may also include modification of image frame resolution to a portion of its original image frame resolution. For example, consider the scenario of when a standard 2K frame with resolution 2048 by 1080 pixels (i.e., having an aspect ratio of 1.90:1) is used to convey a 2.19:1 aspect ratio original movie. If the full width of the original movie frames is to be displayed within the 2K frame, there may be 72 lines of black fillings at both the top and bottom of the image (e.g., such that only the middle 936 rows of pixels in the 2K frame will be used to convey image information). In such scenario, only the actual image portion may be encoded by cropping and/or resizing the 2K image frames to generate the processed image frame. The image aspect ratio or the number of vertical lines of actual original image content may need to subsequently be stored and transmitted through metadata of the multiplexed frame, which will be described in the latter sections.

Referring again to FIG. 3, shown there are depictions of some example processed frames 304, 304′ that have been produced from original image frames 302 (the modifying step illustrated at circle number 3). As illustrated, the resolutions of the processed image 304 and 304′ have been reduced both vertically and horizontally, with the resolution of processed frame 304′ (which corresponds to original image frame F2) having been reduced to a greater extent than that of the resolution of processed frame 304 (which corresponds to original image frame F1).

At step 208, the encoding module 106 may generate masking data that indicates how an output frame can be produced from one of the plurality of the processed frames and another of the plurality of the processed frames (circle number 4 in FIG. 3). Generally, the masking data stores information of the relationship amongst the plurality of image frames 302. For example, this relationship may be determined by performing an analysis of the selected image frames 302, or of the processed frames 304, 304′. Depending on the various embodiments of real world application and the method used for analysis of the selected image frames 302 (or of the processed frames 304, 304′), the masking data may take different forms. For example, the masking data may serve as inputs into various image processing operation(s) that combine the image data of the image frames 302 (or of the processed frames 304, 304′). In an example embodiment, the masking data 316 may be used as a weight map that contains weightings to be given to either the first processed frame 304 or the second processed frame 304′, at given frame locations, when generating the output frame. It will be understood that this example of masking data is provided for illustration purposes only: masking data may generally track a small or a large amount of difference amongst the selected image frames 302, or may contain any other kind of information data that can be used to indicate the relationship amongst the plurality of image frames 302.

In the example of FIG. 3, since the selected image frames 302, or of the processed frames 304, 304′ are consecutive images in a cinematic video stream, it may be the case that there is some difference between the two consecutive image frames. This difference may be due to global or local illumination change, objects movement or camera movement. In some embodiments, the difference between image frames 302 (or of the processed frames 304, 304′), can be simply found by subtracting the second image frame F2 (or the processed frame 304′) from the first image frame F1 (or the processed frame 304), and then thresholding the difference image. The masking data may be generated as a mask containing values of the thresholded result, which will be used to instruct the decoder on how to reconstruct the outputting image frames.

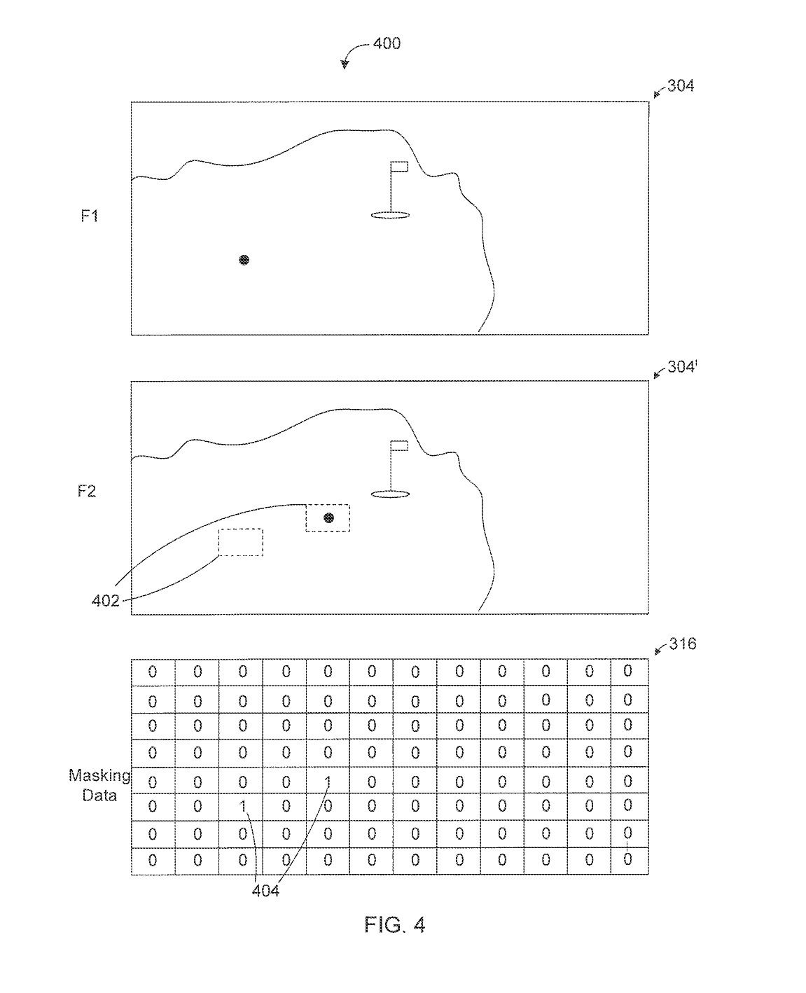

Reference is now to FIG. 4, which shows generally as 400, an illustration of an act of generating masking data in accordance with at least one embodiment of the present disclosure. FIG. 4 continues with the example in FIG. 3 and shows processed frames 304 and 304′ corresponding to original frames F1 and F2 respectively. (The processed frames 304, 304′ in FIG. 4 are shown as having the same resolution to more clearly illustrate the generation of the masking data, even though they may actually have different resolutions). As illustrated, processed frame 304 captures a scene on a golf course in which a golf ball (the dark circle shown in processed frame 304) is moving towards the hole with a flag. A second processed frame 304′ then shows the image frame subsequent to first processed frame 304, in which the golf ball has moved closer to the hole. As can be seen, in consecutive frames for such a scene, the image data of the second processed frame 304′ may be very similar to that of the first processed frame 304, except for the movement of the ball towards the hole. These regions where the second processed frame 304′ differs from the first processed frame 304 can be identified by an analysis of the processed frames 304, 304′, and are shown with dotted rectangles 402 on the second processed frame 304′.

Additionally or alternatively, the differences between each successive frame may be identified from an analysis of the original image frames 302 (as opposed to the processed frames 304, 304′). For example, identifying differences between the second original frame and first original frame may allow for a more accurate determination of the regions that are different between the successive frames because the original frames may contain image data that is of a higher resolution. The location of the differences can then be scaled so that the differences can be identified on the processed frames 304, 304′.

After these particular locations 402 have been identified, the masking data 316 can be created. In various embodiments, the masking data 316 may be considered to be a grid of data, with each position in the grid corresponding to a region on both of processed frames 304 and 304′. For example, in an example scenario in which processed frames 304 and 304′ have been divided into 12 regions horizontally and 8 regions vertically, a 12 by 8 grid of masking data 316 may be generated, with the position of a value in the masking data (e.g., row and column) mapping to a region at the same position (e.g., row and column) in processed frames 304, 304′. The value at each position of the masking data may indicate how processed frame for F2 304′ differs from processed frame for F1 304. In the example masking data 316, binary values of (‘0’ or ‘1’) are used, where ‘0’ indicates that the image data does not change, and ‘1’ indicates that the image data does change, between the processed frame for F1 304 and processed frame for F2 304′. Accordingly, all the positions in the masking data contain a ‘0’, except for positions 404 in masking data 316 that correspond to regions 402 of processed frame 304′ that show the regions where the golf ball was in frame F1, and where the golf ball has moved to in F2. The two ‘1’s in the masking data 316 thus show how the differences between the processed frame for F2 304′ and the processed frame for F1 304 can be identified.

It will be understood that the example masking data is shown as a 12 by 8 grid of data for illustration purposes only. In various alternate embodiments, the exact size and/or number of blocks in the masking data may be determined by another algorithm. For example, the size of masking data region may be set to be proportional to the first or second processed image frames.

As will be explained below with respect to the decoding of a multiplexed frame, the masking data value at a given position of the grid specifies how the image data at the same region on both processed frame 304 and 304′ can be combined to arrive at an output frame. For example, the masking data value may indicate the weighting to be given to one or the other of the processed frames 304 and 304′ for that particular region on the output frame. In the example masking data shown in FIG. 4 that contains binary values as masking data (e.g., where an output frame is generated by either taking data from the first frame or from the second frame, with a ‘0’ in the masking data indicating that data is to be taken from the first frame and a ‘1’ indicating that data is to be taken from the second frame), the output frame corresponding to original image frame F2 may be derived by taking the processed frame for F1 304 and then overlaying it with regions 402 from processed frame for F2 304′ where the masking data contains a ‘1’. The result of such combining would be that the image of the ball and the empty space where the ball has moved to in the processed frame for F1 304 is replaced with an empty space and an image of the ball respectively). Since the remaining regions of processed frame for F1 304 remain unchanged, an output frame corresponding to original image frame F2 can be derived.

In further embodiments, the masking data 316 may not contain only binary values, but fractional values between 0 and 1 as well. If the same size of masking data 316 is required to decode the processed image frames 304 or 304′, then the masking data 316 can be interpolated into the same size as the processed image frames 304 or 304′. The exact value within the range may then indicate the proportions of how the first and second frames are to be blended together for a given region (e.g., a low value may indicate that more of the first frame is to be used, whereas a high value may indicate that more of the second frame is to be used.)

Once the masking data 316 has been generated, the process may proceed to step 210 (circle number 5 in FIG. 3), in which a processed frame of the plurality of processed frames may be partitioned into a plurality of frame components. Step 210 is shown in dotted outline in FIG. 2 to indicate that it is an optional step. That is, in various embodiments, the processed frames 304, 304′ may be directly added to a multiplexed frame 306 without being the frame being partitioned.

Referring again to FIG. 3, shown there are frame components 312 for processed frame for F1 304. The partitioning may then be repeated to produce frame components 312′ for processed frame for F2 304′. The frame components 312 of processed frame for F1 304 are labeled ‘F1A’ and ‘F1B’, and the frame components 312′ of processed frame for F2 304′ are labeled ‘F2A’ and ‘F2B’.

During the partitioning, at least one of the plurality of frame components may be provided with a guard area 314 that overlaps with a portion of another of the plurality of frame components that is adjacent to it. Having a guard area that is overlapping (for example, between frame components 312) may allow for better reconstruction of the processed frame 304 during the decoding of the multiplexed frame. The size of guard area may be a constant pixel width or a predefined percentage of the original frame components. Within the guard area during the decoding, the two combining frame components are gradually blended together to avoid any possible visible seam appearing in the decoded image frames.

It will be understood that the relative sizes of frame components 312, 312′ need not be the same, i.e., sizes of the frame components resulting from the partitioning of the processed frame for F2 304′ may differ from sizes of the frame components resulting from the partitioning of the processed frame for F1 304. Further, whereas the processed frame for F1 304 may be partitioned according to one algorithm, the processed frame for F2 304′ may be partitioned according to another algorithm, as their corresponding frame components 312, 312′ need not have the same image properties.

Optionally, one or more of the frame components 312, 312′ (and/or the processed frames 304, 304′, as the case may be) may be rotated prior to their insertion into the multiplexed frame. This may be performed at step 212 (shown in dotted outline), which involves at least one of the plurality of frame components 312 for the processed frame for F1 304 being rotated to generate a corresponding one or more rotated frame components 312 (circle number 6 in FIG. 3). The rotating may be repeated for the frame components 312′ from the processed frame for F2 304′ to produce corresponding rotated frame components 312′ (with rotated labels ‘F2A’ and ‘F2B’).

At step 214, the plurality of processed frames 304, 304′ (e.g., their corresponding frame components 312, 312′) and the masking data may be combined to form the multiplexed frame 306 (circle number 7 in FIG. 3). An example layout of the various rotated frame components 312, 312′ and the masking data 316 is shown in the multiplexed frame 306 of FIG. 3. The multiplexed frame 306 shows the rotated frame components 312 for F1 (illustrated with rotated labels ‘F1A’ and ‘F1B’) having been added to at the top left and top right hand corners of the multiplexed frame 306. A rotated frame component 312′ for F2 (with rotated label ‘F2A’) is also illustrated as having been inserted between the rotated frame components 312 for F1, and then a rotated frame component 312′ for F2 (with rotated label ‘F2B’) may be inserted below the second frame component 312 for F1 (with rotated label ‘F1B’). The masking data 316 may then be added below the first frame component 312′ for F2 (with rotated label ‘F2A’). As illustrated, the guard areas 314, 314′ identified during the partitioning are still intact in the multiplexed frame 306.

To assist the decoding module 146 to decode the multiplexed frame 306, the multiplexed frame 306 may also store metadata 328 (shown in dotted outline attached to the multiplexed frame 306) specifying how a plurality of output frames can be generated from the plurality of processed frames 304, 304′. As illustrated, the metadata 328 is stored separately from the masking data 316, although it will be understood that in various embodiments, the metadata 328 may include the masking data 316 as well. The metadata 328 may be stored in a dedicated region or any position of the multiplexed frame 306, including the position of the masking data 316 shown in multiplexed frame 306. Additionally or alternatively, at least a portion of the metadata may be stored by way of an invisible watermark of the multiplexed frame.

As used herein, an “invisible watermark” can relate to information embedded into existing data on a frame that may be undetectable during normal processing (e.g., this information may be imperceptible to human viewers when a frame is being viewed), but may otherwise be detectable under a specific process designed for identifying such information. In terms of image frames and multiplexed image frames, the embedded information may, for example, be encoded onto an original image frame, a processed frame, a frame component, masking data, metadata, guard data, or any component in a nested frame.

One example of a watermark can be a group of image pixels in which the intensity values in an original frame could be slightly modified. For example, the intensity values of a pre-defined spatial distribution pattern on the original frame may be modified based on a mathematical transform calculation to embed the information of the watermark. Such slight modification of the intensity values would likely not be perceivable by a human viewer, but would allow the embedded information to be subsequently retrieved (provided the decoder is aware of the pre-defined spatial distribution pattern and the mathematical transform calculation). In various embodiments, the encoded information could relate to metadata, copyright information or other small amount(s) of pertinent information.

A digital watermarked frame component may be considered different from a processed frame component for multiplexing in that it does not increase the data size of the frame or the bandwidth used to transmit the frame by a carrier signal. For example, an invisible digital watermark may be considered to be a trade-off between an amount of visually imperceptible image quality and the ability to carry an extra amount of information within the same bandwidth.

The metadata 328 may include, for example, the aspect ratio of the original image content or the vertical number of lines of actual image content (e.g., as would be the case for the scenario mentioned above if the processed image frames are only a portion of the input original image frames that was cropped, for example). The metadata 328 may additionally or alternatively include the mapping data that can be used to derive the positioning or size information of the frame components 312, 312′ (and/or processed frames 304, 304′, as the case may be) in the multiplexed frame 306. For example, in the example multiplexed frame 306 shown in FIG. 3, the mapping data may indicate the boundaries of the rotated frame components 312 for F1 and the frame components 312′ for F2.

In various embodiments, the mapping data may be a code that indicates a pre-defined layout of the processed frames within the multiplexed frame. For example, when combining the plurality of processed frames and the masking data to form the multiplexed frame, each of the processed frames may be positioned within the multiplexed frame according to a pre-defined layout that is selected from amongst a plurality of different pre-defined layouts (such that the code indicates which pre-defined layout is selected for the particular multiplexed frame).

The plurality of different pre-defined layouts may each correspond to a different type of scene that may be shown in the image frames. For example, it may be the case that certain layouts are better suited to be used with certain types of scenes. Since the encoding of the image frames can be performed offline, and the types of scenes shown in the image frames can be known before encoding, the pre-defined layout can be selected based on the scene shown in the frames to be encoded. A code representing the pre-defined layout can then be provided in the metadata of the multiplexed frame.

The metadata 328 may also include various information about the original image frames 302 so that various aspects of the original image frame 302 may be restored from the processed frames 304, 304′. For example, this information may include an aspect ratio and/or frame size of one or more of the original image frames 302. Additionally or alternatively, the metadata 328 may also include a resolution ratio between the processed frames 304, 304′ (The resolution ratio may be stored in situations where the resolutions of the processed frame for F1 304, and the processed frame for F2 304′ are different.). Further, the frame-multiplexing parameters discussed earlier with respect to step 204 in FIG. 2 may also be stored in the metadata 328.

As will be understood, the information that can be stored in the metadata area 328 may be limited. As a result, the information to be encoded and stored as metadata in the multiplexed frame may have to be carefully selected. For example, in some embodiments, metadata 328 may only stores a frame multiplexing parameter that indicates frame types (e.g., 2D or 3D), while the frame components' sizes, aspect ratio and boundary information can be pre-defined or implicitly derived by the decoder using the image boundary detection algorithms. For example, one such boundary detection algorithm can optimally locate the boundary between two image components by conducting Bayesian posteriori estimation.

As will be understood, the steps of selecting image frames 302 for generating a multiplexed frame 306 according to the method of FIG. 2 may be repeatedly conducted for image frames in an original image frame stream. This may result in the multiplexed image frame stream 120 that can ultimately be provided to the decoding module 146 for decoding and restoring.

A multiplexed frame may generally be compatible with existing infrastructure at a display facility because the frame format of a multiplexed frame will be the same as the frame format for original image frames. A multiplexed frame may also generally survive compression. As a result, a multiplexed frame stream may be able to be processed using existing bandwidth-limited infrastructure.

### Decoding a Multiplexed Frame to Multiple Image Frames

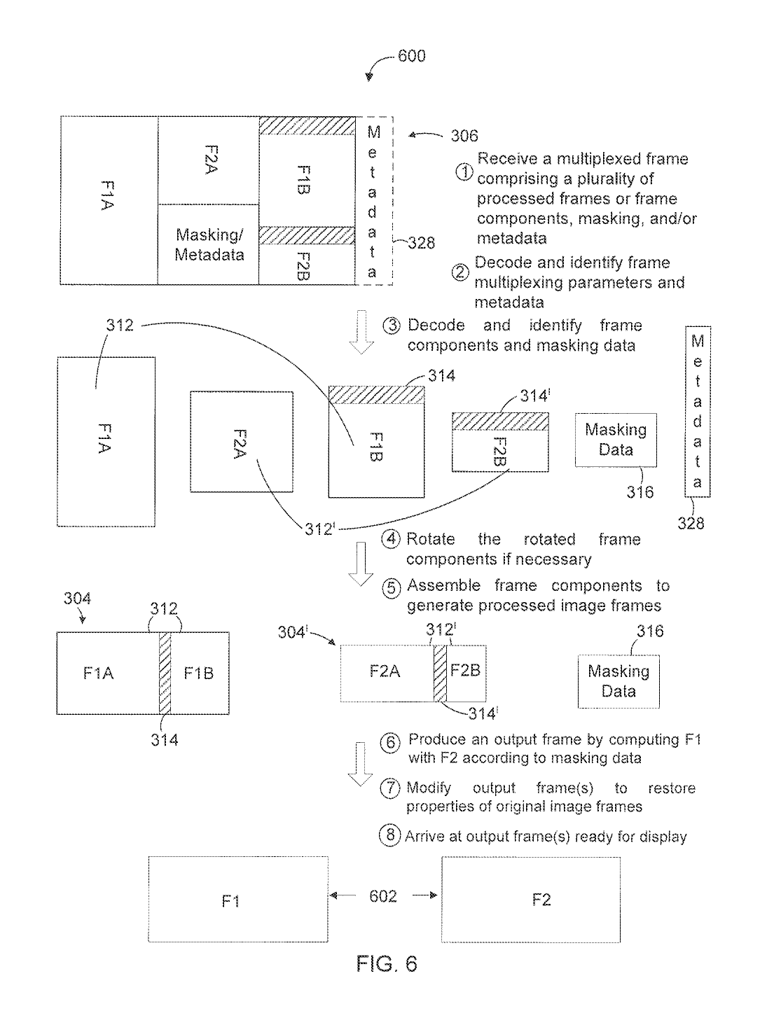

Referring to FIG. 5, shown there generally as 500 is a flowchart diagram illustrating a sequence of acts performed when decoding a multiplexed frame, according to at least one embodiment of the present disclosure. For ease of explanation, reference will simultaneously be made to FIG. 6, which illustrates generally as 600, the progressive transformation of a multiplexed frame into a plurality of output frames. Some of the acts illustrated in FIG. 5 are correspondingly shown in FIG. 6 (notated with a number in a circle) to better explain how the multiplexed frame data is modified during the execution of the steps shown in FIG. 5. The steps of FIG. 5 may be performed by the decoding module 146 shown in FIG. 1.

At step 502, the decoding module 146 at the display facility 140 may receive a multiplexed frame comprising a plurality of processed frames and masking data. The multiplexed frame 306 may be part of a multiplexed image frame stream 120 that is transmitted from a decompression module 144 through a bandwidth-limited communications channel 150, with the multiplexed image frame stream 120 having originally been encoded at the encoding module 106 of pre-processing facility 102.

Referring simultaneously to FIG. 6, this step is shown in circle number 1, and a multiplexed frame 306 is received. For ease of illustration, FIG. 6 continues with the example encoding scenario discussed earlier in FIGS. 2 and 3, to decode the multiplexed frame 306 that was generated in FIG. 3. In this example scenario, the plurality of processed frames comprises a pair of processed frames, which is then processed to produce a pair of output frames. However, it will be understood that the multiplexed frame may include any number of processed frames, which can be processed to produce any number of output frames.

At step 504, the frame-packing parameters may be identified in the multiplexed frame (circle number 2 in FIG. 6). As discussed above, the frame-packing parameters may indicate the type of frames that are present in the multiplexed frame. For example, the frame-packing parameters may indicate that the multiplexed frame may be a nested multiplexed frame such that at least one of the frames encoded into the multiplexed frame is another multiplexed frame. Also, in another example, the frame-packing parameters may indicate that the multiplexed frame contains multiple-view image frames (e.g., a stereoscopic frame pair). The frame-multiplexing parameters may be decoded and identified in the metadata 328. The frame-multiplexing parameters may also possibly be decoded and identified from the invisible watermarking from masking data 316 or metadata 328, according to some embodiments of the present disclosure. The decoding of the watermarked frame can be done by a specific process designed to identify the information encoded in the watermark. For example, if the watermark information was encoded using a mathematical transform calculation, the process to decode the watermarked frame may involve applying the inverse of the mathematical transform calculation. In various embodiments, the decoded information can include the related metadata or some other pertinent information relating to the frame-packing parameters.

At step 506, the method involves unpacking the multiplexed frame 306 to identify the plurality of processed frames and the masking data within the multiplexed frame 306. In the example scenario of FIG. 6, this may involve identifying one or more frame components of a processed frame (circle number 3 in FIG. 6).

The multiplexed frame 306 may also include metadata 328 (shown in dotted outline as attached to multiplexed frame 306) specifying how the plurality of output frames can be generated from the plurality of processed frames. The discussion above regarding how the metadata 328 is stored in a multiplexed frame 306 during the encoding process may also be applicable in this context. That is, during the decoding process, the decoding module 146 may be configured to identify the metadata 328 in the multiplexed frame 306 according to how the metadata 328 was stored within the multiplexed frame 306. For example, if the metadata 328 is stored as a watermark of the multiplexed frame 306, the decoding module 146 may be configured to identify the metadata 328 in the watermark of the multiplexed frame 306.

To identify the position of each of the frame components (and/or processed frames, as the case may be) during the unpacking step, the decoding module 146 may refer to mapping data that is stored in the metadata 328. As discussed above, the mapping data may identify the positioning of the processed frames and/or the frame components stored in the multiplexed frame 306. For example, the mapping data may identify a pre-defined layout that specifies the position of one or more of the processed frames and/or the masking data within the multiplexed frame 306. The pre-defined layout may then be used when identifying the plurality of processed frames and the masking data. Also as discussed above, since the pre-defined layout may be selected from a plurality of different pre-defined layouts, the decoding module may be provided with access to the different pre-defined layouts that may be used to encode image frames into multiplexed frames 306.

In another example, instead of, or in addition to, referring to a pre-defined layout to identify the processed frames and masking data in a multiplexed frame 306, the position of at least one of the processed frames and/or the masking data within the multiplexed frame may be identified according to an image boundary detection analysis of the multiplexed frame. For example one of such algorithms can optimally locate the boundary between any two image components by conducting Bayesian posteriori estimation.

After the frame components (or the processed frames) have been identified, any rotated frame components in the multiplexed frame that were rotated during encoding may be restored to their original orientation. This may be performed at step 508 (shown in dotted outline). At step 508, the method may include rotating the one or more rotated frame components 312, 312′ (circle number 4 in FIG. 6). Step 508 in FIG. 5 is shown in dotted outline because it is optional, as it may be possible that none of the frame components 312, 312′ (or the processed frames 304, 304′ as the case may be) identified in the multiplexed frame 306 are rotated. In various embodiments, the metadata 328 may include data specifying the original orientation of the respective image data so as to allow step 508 to be performed according to the included orientation. Additionally or alternatively, the rotating step 212 during the encoding process in FIG. 2 may be standardized and pre-defined so that the rotation step in the decoding process at step 508 may also be standardized and pre-defined. For example, the encoding module may 106 may be configured to always rotate an image frame or an image frame component 90° clockwise, so that the rotating at step 508 can always be performed 90° counterclockwise to restore the orientation during decoding.

At step 510, one or more frame components 312 may be assembled together to generate the processed frame 304′ (circle number 5 in FIG. 6). This step is also shown in dotted outline because it may be possible that, in various embodiments, the processed frame 304′ may not have been partitioned during the encoding process so as to render this step unnecessary.

As noted above in the discussion regarding the encoding process, during the partitioning of a processed frame into frame components 312, the frame components 312, 312′ may be provided with a guard area 314, 314′ that overlaps with a portion of another of the frame components 312, 312′ for the same processed frame 304, 304′. Accordingly, in the example scenario of FIG. 6, a guard area 314 may be identified or pre-defined for a rotated frame component of F1 312 (with label ‘F1B’). As well, a guard area 314′ may be identified or predefined for a frame component of F2 312′ (with label ‘F2B’). When assembling the frame components 312 for processed frame 304 together, the frame components 312 may be gradually blended with each other at the guard area 314. The blending may also be repeated with the frame components 312′ at guard area 314′ for the processed frame 304′. As will be understood, providing a guard area may allow seamless blending for improved reconstruction of the processed frames.

To generate a plurality of output frames from the plurality of identified processed frames 304, 304′, a first processed frame (e.g., processed frame for F1 304) may first be identified as the base frame that will be the first output frame. Subsequent output frame(s) can then be generated by applying the masking data 316 to the first output frame, and then overlaying the first output frame with region(s) of a subsequent processed image (e.g., processed frame for F2 304′) according to a corresponding value in the masking data 316.

However, before the overlaying can be performed, since the resolutions of the reconstituted processed frames 304, 304′ may be different, the resolution of any subsequent processed frame (e.g., processed frame for F2 304′) may be modified so as to be the same as the resolution of the base first output frame. For example, in the example scenario shown in FIG. 6, the resolution for the processed frame for F1 304 may be higher than that of the resolution for the processed frame for F2 304′. Thus, the resolution of the processed frame for F2 304′ may be scaled up according to a resolution ratio between the two frames (e.g., a ratio of the resolutions between the processed frame for F2 304′ and the processed frame for F1 304). In various embodiments, the resolution ratio may be stored in the metadata 328 of the multiplexed frame 306, for example.

At step 512, an output frame may be produced by combining one of the plurality of processed frames with another of the plurality of processed frames according to the masking data (circle number 6 in FIG. 6). In the example scenario shown in FIG. 6, this may be performed by first selecting the processed frame for F1 304 as the base output frame. The masking data 316 may then be applied to the processed frame for F1 304, so as to indicate how the processed frame for F1 304 can be combined with the processed frame for F2 304′ to generate the output frame corresponding to F2.

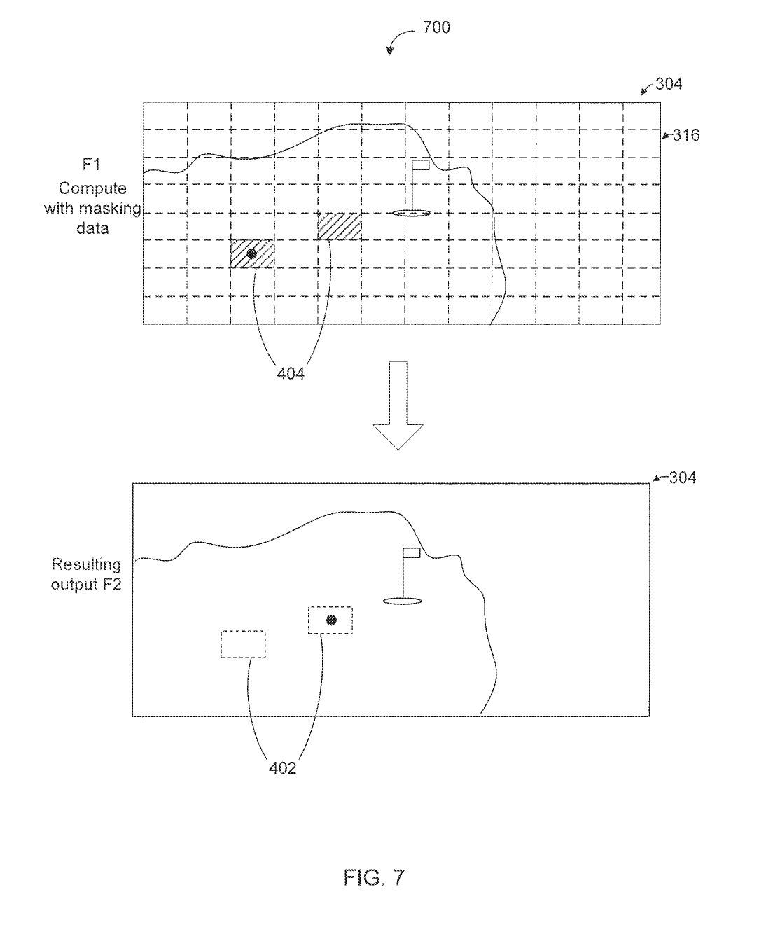

Referring simultaneously to FIG. 7, shown there generally as 700 is an illustration of producing an output frame by combining two processed frames according to masking data. The masking data 316 shown corresponds to the masking data 316 shown in FIG. 4, and accordingly, consists of an 12×8 grid of data that indicates the corresponding regions of the processed frame for F1 304 that have to be overlaid with the same region in the processed frame for F2 304′ when generating an output frame corresponding to F2. This is illustrated in FIG. 7 by having the masking data 316 be directly overlaid on top of the processed frame for F1 304. Referring simultaneously to FIG. 4, it can be seen that the regions 404 that are to be replaced with corresponding regions from the processed frame for F2 304′ (i.e., the positions in the masking data 316 shown in FIG. 4 as having a value of ‘1’) are shown in cross-hatch. Before applying the masking data to combine the processed frames 304, 304′, the masking data 316 may also be resized to conform to the size of the processed frame for F1 304.

After applying the masking data 316 to the processed frame for F1 304, the output frame corresponding to the processed frame for F2 304′ may be produced. Still referring to FIG. 7, shown below processed frame for F1 304 being overlaid with the masking data 316 is the resulting output frame F2 that corresponds to the processed frame for F2 304′. As illustrated, the resulting output frame F2 is generated from the processed frame for F1 304, with selected regions 402 identified by the masking data 316 having been replaced with the same regions from the processed frame for F2 304′. Since this particular example pair of image frames show the movement of a golf ball towards a hole, the regions 402 have replaced: (i) the region that used to show the golf ball with an image that shows that the ball is no longer there; and (ii) the region that used to not show a ball, with a region that shows where the golf ball has moved to.

At step 514, once the output frame F1 has been identified, and the output frame F2 has been produced, the output frames may be modified to restore the properties of the original image frames (circle number 7 in FIG. 6). As discussed above, the metadata 528 may have stored various properties of the original image frames 302 shown in FIG. 3. Accordingly, these properties may be referenced when performing step 514. For example, the modifying of the output frames 602 may include restoring the aspect ratio of the original image frames 302, or restoring the vertical or horizontal resolution of the original image frames 302. It may also include adding back rows of empty visual data to the top and bottom of the decoded processed image frames to restore the appearance of the original image frame (e.g., if the decoded processed image frames are only a portion of the original image frames that were cropped from the original image frame, as discussed above, for example). As will be understood, empty visual data may appear as black strips in the top and bottom portions of an output frame.

At step 516, the output frames ready for display can be arrived at (circle number 8 in FIG. 6). Once the output frames 602 have been restored according to the original image properties, the output frames 602 may be inserted into an output frame stream that can be displayed by a display device 148 in FIG. 1. In various embodiments, the decoding of the multiplexed frames 306 in a multiplexed image frame stream 120 may be performed in real-time by the decoding module 146 at display facility 140, immediately before the output frame stream is provided to the display device.

### Nested Multiplexed Frames

While the above discussion relates to the encoding of image frames directly into a multiplexed frame, in various embodiments, it may also be possible to encode another multiplexed frame into a multiplexed frame, so as to generate a nested multiplexed frame.

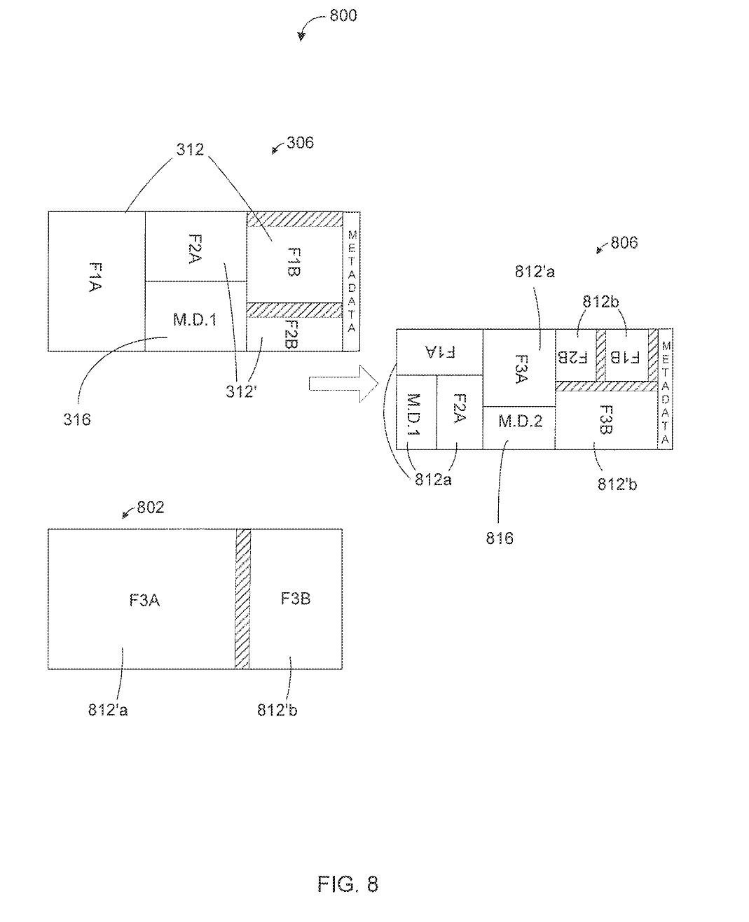

Referring to FIG. 8, a nested encoding method 800 is a transformation of a multiplexed frame 306 and a third processed frame 802 (that corresponds to a third image frame F3 (not shown)) into a nested multiplexed frame 806, in accordance with at least one embodiment of the present disclosure. As will be understood, the method of generating a nested multiplexed frame will be similar to that of generating a regular multiplexed image frame, except that it is a multiplexed image frame and a processed frame that are being combined in a subsequent encoding process.

For example, the method of generating a nested multiplexed frame may include identifying a multiplexed frame 306 which itself comprises a first processed frame that corresponds to a first image frame, and a second processed frame that corresponds to a second image frame. A third image frame F3 from an image frame stream may then be identified. As previously described, a first multiplexed frame 306 may contain: frame components 312 for an original image frame F1, frame components 312′ for an original image frame F2, and masking data for the multiplexed frame 306; where the masking data represents the relationship between image frame F2 and image frame F1. The masking data and metadata associated with the first multiplexed frame may be retained in the section 316 and is referred to as “M.D. 1” in the Figures. The intermediate steps for encoding the multiplexed frame 306 are shown in FIG. 3 but not shown in FIG. 8.

FIG. 8 illustrates the multiplexed frame 306 and the third processed image frame 802 packed or multiplexed into a nested multiplexed frame 806. The first frame component section 812a of the nested multiplexed frame 806 includes processed frame components with labels ‘F1A’ and ‘F2A’, as well as the masking data 316 for the multiplexed frame 306 that can be packed by resizing and rotating as shown. Similarly, the second frame component section 812b of the nested multiplexed frame 806 includes processed frame components with labels ‘F1B’ and ‘F2B’ that can be packed by resizing and rotating as shown. Information related to rotation and resizing, such as the scheme used to do both, can be stored as metadata associated with the nested multiplexed frame 806 in section 816.

Similar to multiplexing processed frame components in 306, processed frame components 812′a and 812′b for the third processed frame 802 can be packed into the nested multiplexed frame 806 where 812′a is a first frame component of the third processed image frame 802 (with label ‘F3A’) and where 812′b is a second frame component of the third processed frame 802 (with label ‘F3B’). Both frame components can be rotated and inserted into the nested multiplexed frame 806. The nested multiplexed frame may contain frame components 812′a and 812′b for a processed image frame 802, and masking and metadata 816 (labeled “M.D. 2” in FIG. 8) for the nested multiplexed frame 806. The masking data in “M.D. 2” may represent the relationship between image frame F3 and image frame F2. The metadata in in nested multiplexed frame 806 may represent how the third processed frame 802 and the multiplexed frame 306 are multiplexed together. For example, the metadata for the nested multiplexed frame 806 may include information regarding how the frame components and mask/metadata “M.D. 1” within the multiplexed frame 306 can be resized and packed when creating the nested multiplexed frame 806.

In further embodiments, the creation of a nested multiplexed frame 806 may be further repeated when the nested multiplexed frame itself is further encoded into yet another nested multiplexed frame. This process of recursively multiplexing image frames may continue to be repeated until a minimum quality level in the processed frames is reached during the encoding process.

To decode a nested multiplexed image frame, a similar decoding process as was described above with regards to FIGS. 5-7 may be used.

Generating the output image frames from a nested multiplexed frame requires the third output image frame to be generated from the second processed frame; and before generating the second output image frame, the first processed frame needs to be identified. Therefore, the layers of nesting of recursively nested multiplexed frame may have to be “unraveled” (e.g., each of the nested processed image frames must be unpacked and identified) before any of the output image frames can be generated.

As will be understood, the steps of the decoding method of the multiplexed frames can generally be similar to the encoding steps carried out in a reverse order. In the example illustrated in FIG. 8, the decoding may first involve identifying the frame components 812a, 812b in the nested multiplexed frame 806, so as to be able to reconstruct the initial multiplexed frame 306. The unpacking may also involve identifying the frame components 812′a, 812′b in the nested multiplexed frame 806, so as to be able to reconstruct the third processed frame 802.

To generate the third output frame F3 in the FIG. 8, for example, the initial multiplexed frame 306 would then have to be decoded to generate the first and second processed frames based on the masking data 316 associated with the initial multiplexed frame 306. Thereafter, the third output frame can then be generated by combining the second processed frame and the third processed frame using masking data 816 associated with the next level nested multiplexed frame 806.

This process may continue where further nesting of multiplexed frames has occurred until the last output image frame of the last nested multiplexed frame is generated. The decoding order of all the output image frames thus occurs in the same order as encoding the image frames.

The decoding method may include receiving: a nested multiplexed frame that comprises a processed multiplexed frame of a first processed frame and a second processed frame; a third processed frame; and masking and metadata at this nested multiplexing level. The decoding module can use the metadata associated with the nested multiplex frame to unpack the nested multiplexed frame to identify the processed multiplexed frame, the third processed frame, and the masking data associated within the nested multiplexed frame that is at a lower nested multiplexing level.

The method may then unpack the nested multiplexed frame by identifying and reconstructing the multiplexed frame using the metadata associated with the nested multiplexed frame. Once reconstructed, the multiplexed frame can then be decoded using the metadata associated with the multiplexed frame to identify the first processed frame, the second processed frame, and the masking data.

Once the processed frames are generated, the method may then proceed to generate output image frames corresponding to the processed frames, i.e. the first output image frame, the second output image frame and third output image frame to reconstruct the original high frame rate image sequence for display.

### Multiple-View Image Frames Multiplexing

In various embodiments, the encoding and decoding process described in the present disclosure may be applied to the field of multiple-view image frame streams (e.g., a frame stream having image frames that provide different views of the same scene).

An example of a multiple-view image frame stream is a three-dimensional (3D) cinematic video stream in which two views of a scene (e.g., a stereoscopic frame pair containing one view for a left eye, and the other view for the right eye) are provided. As is known, the viewing of the different views together (or quickly in succession) allows the perception of depth that generates the 3D effect. In these types of 3D cinematic video streams, alternating scenes for each eye may be shown sequentially, and polarized glasses may be used to only allow each eye to see the view that is intended for it.

As discussed above, traditional cinematic video is typically provided at 24 fps. To allow for alternating left and right views of a scene in 3D cinematic video, twice the number of frames per second would have to be provided in a 3D cinematic image frame stream so as to maintain the traditional frame rate of 24 fps perceived by each eye (e.g., although the actual frame stream may be displayed at 48 fps, only half of these frames are directed to each eye in any given second). 3D cinematic image frame streams are thus typically provided at 48 fps, and thus may suffer from the similar bandwidth constraints described above. Accordingly, 3D cinematic image frame streams may be suitable candidates for the encoding and decoding processes described in the present disclosure.

Referring to FIG. 9, shown there generally as 900 is an illustration of transforming an example multiple-view image frame stream into a multiplexed image frame stream in which the image frames from different views are encoded together, in accordance with at least one embodiment of the present disclosure. In this particular example, an original 3D image frame stream is shown with a sequence of stereoscopic pairs 902, 902′, 902″ (labeled L₀ and R₀ for view ‘0’; L₁ and R₁ for view ‘1’; and L₂ and R₂ for view ‘2’). In this embodiment, multiple views of the same scene are multiplexed together. Accordingly, after the 3D image frame stream is processed through the encoding process described above, the result may be a multiplexed image frame stream in which each multiplexed frame contains both frames of a stereoscopic frame pair. For example, as illustrated, the multiplexed frame 906 includes both frames of the stereoscopic frame pair 902 (original frames labeled L₀ and R₀). Similarly, multiplexed frame 906′ includes both frames of the stereoscopic frame pair 902′ (original frames labeled L₁ and R₁), and multiplexed frame 906″ includes both frames of the stereoscopic frame pair 902″ (original frames labeled L₂ and R₂).

For multiplexing of stereoscopic frames, masking data generation may be different from what was described in the previous examples for better efficiency. For example, the analysis of difference between two different views of images may consider the scene depth and known or detected stereoscopic model parameters. In such embodiments, the scene depth information may be transmitted as a part of masking data, for example.

Referring to FIG. 10, shown there is an illustration of another embodiment of encoding an original 3D image frame stream. Particularly, method 1000 shows the transformation of an example multiple-view image frame stream into a multiplexed image frame stream in which successive image frames for the same view are encoded together, in accordance with at least one embodiment of the present disclosure. Similar to FIG. 9, an original 3D image frame stream is shown with a sequence of stereoscopic pairs. However, in this embodiment, sequential frames for the same view are encoded instead of different views of the same scene being encoded. Since the sequential frames for the same view capture a scene over a period of time, this may be considered a temporal encoding of the 3D image frame stream.

As illustrated, a first plurality of original image frames 1002 may be selected to be encoded (e.g., the left-eye view of scenes ‘0’ and ‘1’ labeled frames L₀ and L₁) to produce a resultant multiplexed frame 1006 containing original frames labeled L₀ and L₁. Similarly, a second plurality of original frames 1002′ may be selected to be encoded (e.g., the right-eye view of scenes ‘0’ and ‘1’ labeled frames R₀ and R₁) to produce a resultant multiplexed frame 1006′ containing original frames labeled R₀ and R₁. The process of encoding may then be performed repeatedly, altering between sequential temporal pairs for each of a left-eye and a right-eye view of a scene. The result will be a multiplexed image frame stream that maintains the characteristic of a 3D video stream that provides left-eye and right-eye views in alternating sequence.

The process for generating output frames from a multiplexed image frame resulting from the embodiments shown in FIGS. 9 and 10 is similar to that described above with respect to FIGS. 5-7 above. Depending on the method of encoding the 3D image frame stream (e.g., view encoding in FIG. 9 versus temporal encoding in FIG. 10), the decoding module 146 may be configured to reconstruct the sequence of the original 3D image frame stream accordingly.

Referring to FIG. 11, shown there is an illustration of the embodiment of encoding an original high frame rate (HFR) image frame stream. Particularly, method 1100 shows the transformation of an example HFR image frame stream into a multiplexed lower frame rate image frame stream in which successive image frame pairs are encoded together, in accordance with at least one embodiment of the present disclosure. As illustrated, a first plurality of original image frames 1102 may be selected to be encoded (e.g., the index number of frame ‘0’ and the index number of frame ‘1’ labeled frames I₀ and I₁ respectively) to produce a resultant multiplexed frame 1106 containing original frames labeled I₀ and h. Similarly, a second plurality of original frames 1102′ may be selected to be encoded (e.g., the index number of frames ‘2’ and ‘3’ labeled frames I₂ and I₃ respectively) to produce a resultant multiplexed frame 1106′ containing original frames labeled I₂ and I₃. The process of encoding may then be performed repeatedly, folding sequential temporal frame pairs into a series of multiplexed frames. The result will be a multiplexed image frame stream that contains all the original HFR frames but now with only a half number of multiplexed frames (i.e., the multiplexed image frame stream contains half the number of frames of the original image frame stream), therefore effectively reducing the needed bandwidth for transmission.

The process for generating output frames from a multiplexed image frame resulting from the embodiments shown in FIG. 11 is similar to that described above with respect to FIGS. 5-7 above. The decoding module 146 (as shown in FIG. 1) may be configured to reconstruct the sequence of the original HFR image frame sequence.

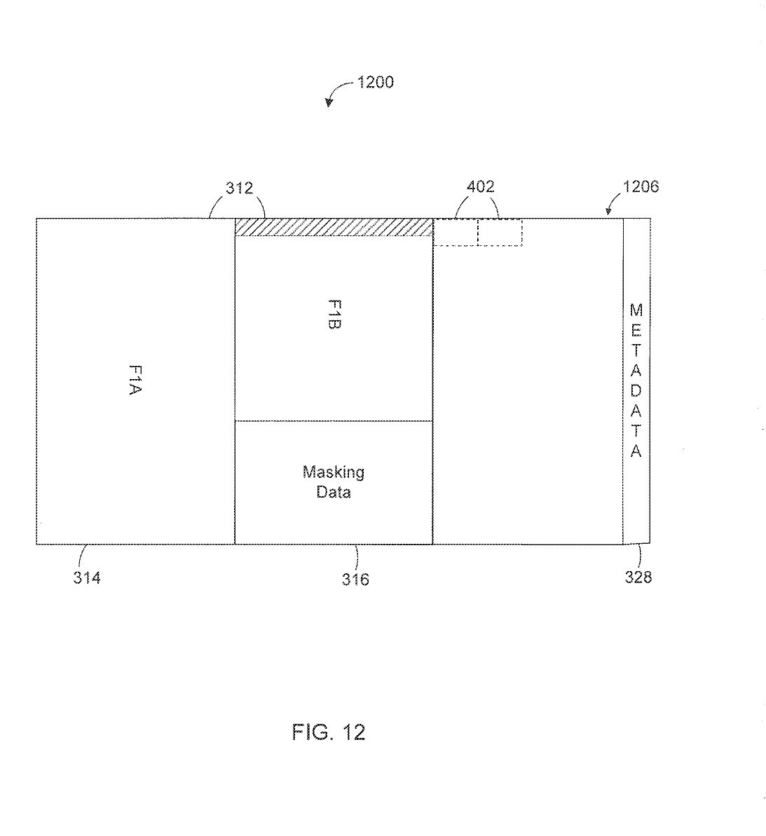

Referring to FIG. 12, shown there generally as 1200 is an alternate embodiment for the layout of a multiplexed frame, in accordance with an embodiment of the present disclosure. In this alternate embodiment, instead of the second processed frame 304′ reflecting the entirety of the second original frame 302, the second processed frame is limited to just the regions 402 of the second original image frame 302 that are to be used when generating an output frame. This may allow the data for the remainder of the second frame 302 (that may not be used in generating an output frame) to be omitted from the multiplexed frame 1206. The savings of bandwidth resulting from this omission may allow the region 402 data to be added to the multiplexed frame 306 at a higher quality (e.g., a higher resolution).

As illustrated, in the example scenario described above for packing a pair of original image frames F1 and F2 into a multiplexed frame, the frame components 312 for F1 (labeled ‘F1A’ and ‘F1B’) may be added to the multiplexed frame 1206. As well, instead of a processed frame for F2 that reflects the entirety of original frame F2 being added to the multiplexed frame 1206, only the regions 402 from the original second frame F2 (that are later used to generate an output frame) may be added to the multiplexed frame 1206.

The masking data 316 may be generated in a manner similar to what was described earlier, i.e., to show the regions of F1 that need to be overlaid with regions 402 when generating the output frame for frame F2. However, to allow the decoding module to associate a given position of the original frame F1 with a specific region 402, the multiplexed frame 1206 may also include mapping data in the metadata 328.

As the metadata 328 may only allow a small amount of data to be losslessly transmitted, in various embodiments, the layout of the positions of F1 (e.g., the 12×8 grid of data discussed earlier) may be fixed so that layout information need not be transmitted in the mapping data. In such case, the mapping data may simply provide a sequence of indices into the grid that specify the positions of F1 that need to be replaced with the respective sequence of regions 402 provided in the multiplexed frame 1206.

In some embodiments, the mapping data may additionally or alternatively be provided by way of another data channel separate from the metadata 328.

It will be understood that various aspects of the encoding method illustrated in FIGS. 2-4 may change depending on the nature of the selected image frames. The size, number and arrangement of all the described components for a multiplexed frame are reconfigurable and new configuration can be explicitly or implicitly transmitted from the encoding module to the decoding module. For example, the size of the generated masking data and/or metadata in the multiplexed frame 306 for one plurality of image frames may differ from a size of the generated masking data and/or metadata in the multiplexed frame 306 for another plurality of image frames. Also, the layout of the frame components and/or processed frames in the multiplexed frame 306 may also be different.

Further, in various embodiments, the factors that affect the encoding process may be pre-selected depending on the type of scene being shown in the image frames. That is, since the encoding may be performed offline with full knowledge of the properties of the image frames to be multiplexed, it may be possible to determine that a particular configuration of the described encoding process may be better suited for certain selected sequences of the original image frame stream.

In these embodiments, there may be a pre-selected number of such scene-specific configurations of the encoding process which can then be selected based on the original image frame stream. These scene-specific configurations may be provided at the decoding module 146, so that the multiplexed frame 306 need only store a scene-specific configuration identifier that will indicate to the decoding module 146 how the multiplexed frame 306 is to be decoded. For example, as discussed above, an example of such an identifier may be a code to indicate which pre-defined layout is used to position frame components within a multiplexed frame.

The present invention has been described here by way of example only. Various modification and variations may be made to these exemplary embodiments without departing from the scope of the invention, which is limited only by the appended claims. For example, the steps of a method in accordance with any of the embodiments described herein may be performed in any order, whether or not such steps are described in the claims, figures or otherwise in any sequential numbered or lettered manner.

We claim:

1. A method of dynamic frame packing, the method comprising:
identifying a plurality of image frames;
modifying each of the plurality of image frames to generate a plurality of corresponding processed frames;
generating masking data that indicates how an output frame can be produced from one of the plurality of processed frames and another of the plurality of processed frames, the output frame corresponding to the another of the plurality of processed frames; and
combining the plurality of processed frames and the masking data to form a multiplexed frame.

2. The method of claim 1, wherein when combining the plurality of processed frames and the masking data to form a multiplexed frame, each of the processed frames are positioned within the multiplexed frame according to a pre-defined layout.

3. The method of claim 2, wherein the pre-defined layout is selected from a plurality of different pre-defined layouts, the selecting being performed based on a type of scene shown in the image frames.

4. The method of claim 3, wherein each of the plurality of different pre-defined layouts correspond to a different type of scene.

5. The method of claim 1, further comprising modifying an aspect ratio of each of the plurality of image frames when generating the plurality of corresponding processed frames.

6. The method of claim 1, wherein the modifying each of the plurality of image frames comprises taking a portion of the original image frames to generate the plurality of corresponding processed frames.

7. The method of claim 1, wherein prior to the combining, the method further comprises
partitioning a processed frame of the plurality of processed frames into a plurality of frame components;
and wherein the combining comprises adding the one or more frame components to the multiplexed frame.

8. The method of claim 7, further comprising rotating at least one of the plurality of frame components, prior to adding the one or more frame components to the multiplexed frame.

9. The method of claim 7, wherein during the partitioning, at least one of the plurality of frame components is provided with a guard area that overlaps with a portion of another of the plurality of frame components.

10. The method of claim 7, wherein the method further comprises repeating the partitioning and adding for another processed frame of the plurality of processed frames, and wherein sizes of the frame components resulting from the partitioning of the another processed frame differ from sizes of the frame components resulting from the partitioning of the processed frame.

11. The method of claim 1, further comprising storing metadata in the multiplexed frame, the metadata specifying how a plurality of output frames can be generated from the plurality of processed frames.

12. The method of claim 11, wherein the metadata comprises the aspect ratio of the plurality of image frames.

13. The method of claim 11, wherein the metadata comprises a resolution ratio between the one of the plurality of processed frames and the another of the plurality of processed frames.

14. The method of claim 11, wherein the metadata comprises mapping data that identifies positioning of the processed frames in the multiplexed frame.

15. The method of claim 11, wherein at least a portion of the metadata is stored as a watermark.

16. The method of claim 1, wherein the plurality of image frames comprises a pair of image frames, and the plurality of corresponding processed frames comprises a pair of processed frames.

17. The method of claim 1, wherein the identifying comprises selecting the plurality of image frames from an image frame stream.

18. The method of claim 17, further comprising repeating the identifying, modifying, generating and combining for another plurality of image frames from the image frame stream.

19. The method of claim 18, wherein a size of the generated metadata for the another plurality of image frames differs from a size of the generated metadata for the plurality of image frames.

20. The method of claim 1, wherein the another of the plurality of processed frames comprises only regions that are to be used when generating the output frame.

21. The method of claim 20, where the regions are of a resolution that is substantially similar to the resolution of the one of the plurality of processed frames.

22. A method of decoding a multiplexed frame, the method comprising:
receiving a multiplexed frame, the multiplexed frame comprising:
a plurality of processed frames, and
masking data;
unpacking the multiplexed frame to identify the plurality of processed frames and the masking data; and
generating a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames.

23. The method of claim 22, wherein when unpacking the multiplexed frame to identify the plurality of processed frames and the masking data, the position of at least one of the processed frames within the multiplexed frame is identified based on a pre-defined layout.

24. The method of claim 23, wherein the pre-defined layout is selected from a plurality of different pre-defined layouts, the selecting being performed according to mapping data provided in the multiplexed frame.

25. The method of claim 22, wherein when unpacking the multiplexed frame to identify the plurality of processed frames and the masking data, the position of at least one of the processed frames within the multiplexed frame is identified according to an image detection analysis of the multiplexed frame.

26. The method of claim 22, wherein during the unpacking, the method further comprises
identifying, in the multiplexed frame, one or more frame components of a processed frame; and
assembling the one or more frame components together to generate the processed frame.

27. The method of claim 26, wherein the identified one or more frame components are rotated, and the method further comprises rotating the one or more frame components prior to the assembling.

28. The method of claim 26, wherein at least one of the one or more frame components is provided with a guard area that overlaps with a portion of another of the one or more frame components, and wherein the method further comprises blending the at least one of the one or more frame components with the another of the one or more frame components at the guard area.

29. The method of claim 22, wherein the plurality of processed frames comprises a pair of processed frames, and the plurality of output frame comprises a pair of output frames.

30. The method of claim 22, wherein the multiplexed frame further comprises metadata specifying how the plurality of output frames can be generated from the plurality of processed frames.

31. The method of claim 30, wherein the metadata comprises an aspect ratio, and the generating further comprises modifying the output frame to conform to the aspect ratio.

32. The method of claim 30, wherein the metadata is identified in a watermark.

33. The method of claim 30, wherein the metadata comprises a resolution ratio between the one of the plurality of the processed frames and the another of the plurality of the processed frames, and the generating comprises modifying a resolution of the one of the plurality of the processed frames or the another of the plurality of the processed frames, according to the resolution ratio.

34. The method of claim 30, wherein the metadata comprises mapping data that identifies the positioning of the processed frames in the multiplexed frame, and the unpacking comprises identifying the processed frames in the multiplexed frame based on the mapping data.

35. The method of claim 22, wherein the plurality of output frames comprise consecutive image frames in an image frame stream.

36. The method of claim 22, wherein each of the plurality of output frames provides a different view of a scene shown in the plurality of processed frames.

37. The method of claim 36, wherein the plurality of output frames comprises a stereoscopic frame pair.

38. The method of claim 22, wherein the another of the plurality of processed frames comprises only regions that are to be used when generating the output frame.

39. The method of claim 38, where the regions are of a resolution that is substantially similar to the resolution of the one of the plurality of processed frames.

40. A method of delivering multiplexed frames, the method comprising:
identifying an image frame stream;
selecting a plurality of image frames from the image frame stream;
modifying each of the plurality of image frames to generate a plurality of corresponding processed frames;
generating masking data that indicates how an output frame can be produced from one of the plurality of processed frames and another of the plurality of processed frames, the output frame corresponding to the another of the plurality of processed frames;
combining the plurality of processed frames and the masking data to form a multiplexed frame;
compressing the multiplexed frame to generate a compressed frame; and
transmitting the compressed frame.

41. The method of claim 40, wherein the compression module is configured to compress the multiplexed frame based on JPEG 2000 standard.

42. A method of displaying image frames from multiplexed frames, the method comprising:
receiving a compressed frame;
decompressing the compressed frame to generate a multiplexed frame, wherein the multiplexed frame comprises:
a plurality of processed frames, and
masking data;
unpacking the multiplexed frame to identify the plurality of processed frames and the masking data;
generating a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames; and
transmitting the plurality of output frames to at least one display device.

43. A system for transmitting a multiplexed frame, the system comprising:
a receiving module configured to receive a plurality of image frames;
an encoding module configured to:
modify each of the plurality of image frames to generate a plurality of corresponding processed frames;
generate masking data that indicates how an output frame can be produced from one of the plurality of processed frames and another of the plurality of processed frames, the output frame corresponding to the another of the plurality of processed frames; and
combine the plurality of processed frames and the masking data to form a multiplexed frame;
a compression module configured to compress the multiplexed frame to generate a compressed frame; and
a communication module configured to transmit the compressed frame.

44. The system of claim 43, wherein the modifying, generating, and combining performed by the encoding module are performed offline.

45. A system for decoding a multiplexed frame for display, the system comprising:
a decompression module configured to decompress the compressed frame to restore the multiplexed frame; and
a decoding module configured to:
unpack the multiplexed frame to identify a plurality of processed frames and masking data; and
generate a plurality of output frames from the plurality of processed frames, wherein the generating comprises producing an output frame by combining one of the plurality of processed frames with another of the plurality of processed frames according to the masking data, and wherein the output frame corresponds to the another of the plurality of processed frames.

46. The system of claim 45, wherein the unpacking and generating performed by the decoding module are performed in real-time.

47. A method of generating a nested multiplexed frame, the method comprising:
identifying a multiplexed frame comprising: a first processed frame that corresponds to a first image frame, and a second processed frame that corresponds to a second image frame;
identifying a third image frame;
modifying the multiplexed frame and the third image frame to generate a corresponding processed multiplexed frame and a corresponding third processed frame respectively;
identify masking data that indicates how an output frame can be produced from the second processed frame and the third processed frame, the output frame corresponding to the third image frame; and
combining the processed multiplexed frame, the third processed frame and the masking data to form a nested multiplexed frame.

48. A method of decoding a nested multiplexed frame, the method comprising:
receiving a nested multiplexed frame, the nested multiplexed frame comprising:
a processed multiplexed frame that comprises a first processed frame and a second processed frame,
a third processed frame, and
masking data;
unpacking the nested multiplexed frame to identify the processed multiplexed frame, the third processed frame, and the masking data;
decoding the processed multiplexed frame to identify the first processed frame and the second processed frame; and
generating an output frame, wherein the generating comprises combining the second processed frame with the third processed frame according to the masking data, and wherein the output frame corresponds to the third processed frame.
